(19) United States
(12) Patent Application Publication
(10) Pub. No.: US 2010/0040774 A1
(43) Pub. Date: Feb. 18, 2010

(54) Method and Device to Cure and Prevent Athlete's Foot in a Shower Setting

(76) Inventor: Jason R. Russell, Gillette, WY (US)

Correspondence Address: Jason Russell, 1910 Harvest Moon Drive, Gillette, WY, 82718, US

(21) Appl. No.: 12/344,297

(22) Filed: Dec. 26, 2008

Related U.S. Application Data
(60) Provisional application No. 61/088,834, filed on Aug. 14, 2008.

(51) Int. Cl. B05D 1/02; B05C 11/00

(52) U.S. Cl. 427/154; 118/600

(57) ABSTRACT

The present invention is a passive means of treating athlete's foot and/or other foot related skin ailments (i.e., toenail fungus, cracked heals, etc.) while taking a shower. The user would purchase the system which is comprised of a plastic or stainless steel cage, and a medicinal or herbal fragrance tablet similar to a urinal cake in size. The cage uses a suction cup or other means to attach to the side or floor of a bathtub or shower stall, and is hinged and opens to accept the tablet. As the user showers, the impact of water off the body and surrounding walls dissolve the tablet over time, thus treating the user's feet by coming into contact with the medicated water. The herbal or fragrance tablets could be used by a person that doesn't suffer from athlete's foot but enjoys an aromatic or skin softening effect.

This application claims the benefit of prior filed U.S. Provisional Application Ser. No. 61/088,834, filed Aug. 14, 2008.

### BACKGROUND OF THE INVENTION

1. Field of the Invention

The invention relates generally to a method and device to cure and prevent athlete's foot in a shower setting.

2. Background

Currently available methods of preventing and curing athlete's foot require the user to manually apply a cream, spray, gel, or powder daily to obtain the desired effects until the condition is resolved, as well as regular applications for the prevention of athlete's foot. The current methods are geared for a single user. There does not exist a prevention/cure method designed for multiple user sites, such as shared or public shower facilities. There are no products for the shower setting that give the user the freedom to choose what type of treatment they desire for their foot care routine, such as scents and lotions, without having to actively apply the product.

It would be desirable to have an invention that would fill the need for a passive means of treating and preventing athlete's foot.

### SUMMARY OF THE INVENTION

The present invention advantageously fills the aforementioned deficiencies by providing a method and device to cure and prevent athlete's foot in a shower setting.

The present invention is a method and device for the delivery of a substance to cure and prevent athlete's foot in a shower setting when impacted by water. It is comprised of a small cage, anywhere from 3″-6″ in diameter and 1″-3″ in width, comprised of plastic, polymers, stainless steel or other materials, hinged on one side with a snap closure on the opposite side. The cage opens to accept a large tablet, approximately 2″-6″ in diameter and 1″-3″ thick, comprised of an athlete's foot medication and an inert filler(s). The cage would attach to the side of the shower stall or bathtub utilizing one or more suction cups for easy removal and replacement, or a mounting bracket that would be attached via screws, glue, or any other adhesive. As the person showers, water impacting and running off of the tablet will dispense medication as it splashes over, under, and around the feet as it moves down the shower or tub and towards the drain. As each tablet dissolves the user then simply inserts a refill tablet.

The different ways this invention could be utilized include a regular, extra, or maximum strength (dose) athlete's foot medication tablet. This would allow the user more flexibility in their decision process of which tablet is right for their condition. The tablets could also be made for non-athlete's foot applications, such as: 1) a fragrant substance bonded with fillers to provide the user with a scent pleasurable to the showering experience, as well as making the feet aromatic; 2) a skin softening agent bonded with fillers that softens and moisturizes the users feet; 3) different herbal or organic extracts bonded with fillers that the user finds necessary for their shower routine.

The tablets could be made in nearly any color, scent, shape or size that the cage would accommodate. The cage could be produced in nearly any color or shape currently available to modern production methods.

The present invention device is unique when compared with other known devices and solutions because the present invention provides: (1) an easy and efficient means of delivering athlete's foot medication to the user's feet; (2) relief from the user having to actively apply medication daily; and (3) allows protection for multiple users without the need for the users to perform any extra steps in their usual routine, such as a public or shared shower facility. Similarly, the associated method is unique in that it: (1) can accommodate different types of tablets for different desired effects; (2) is a passive method of regular prevention of athlete's foot; and (3) can protect against athlete's foot simply through routine showering.

This method is very simple and the user only needs to remember to put in a new refill tablet, consisting of an FDA approved athlete's foot medication bonded with an inert filler to produce a dissolvable solid, when the current tablet has dissolved. The other option for a tablet's composition could be herbal substances, fragrant substances, or skin softening substances bonded with a dis-solvable filler. If a person showering does not require the desired effects, such as a multi-person household, dormitory, etc., they may remove the suction cup unit and place it out of the way of the impacting water. This method and device would also prove valuable in a public shower setting such as a dormitory, military base, public swimming pool, gym or recreation center, school locker room, or anywhere else multiple persons are walking about barefoot in a wet environment.

Finally, it is an object of the present invention to provide a method and device to cure and prevent athlete's foot in a shower setting that does not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a perspective view of the invention 10.

FIG. 2 is an enlarged partial cross section view showing the snap clasp 14a and the retaining clip 14b.

FIG. 3 is an exploded perspective view of the invention 10.

FIG. 4 is a perspective view of the invention 10 shown in use.

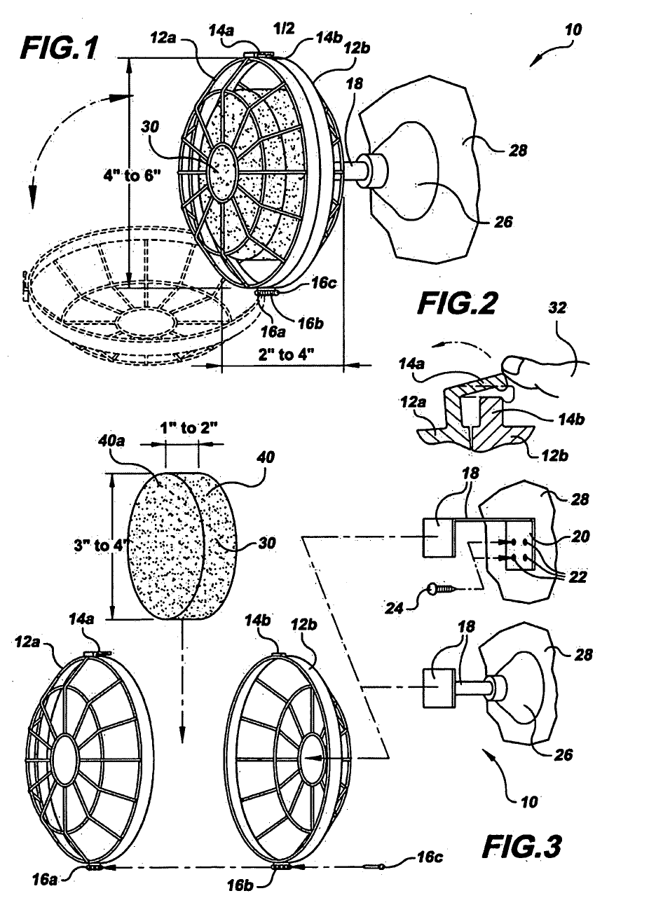

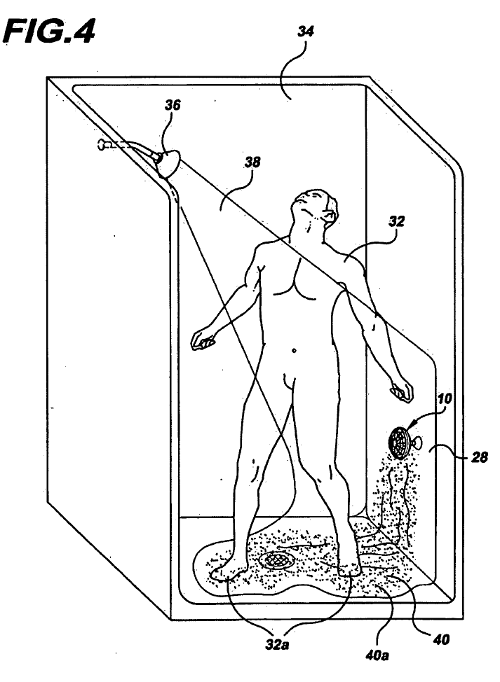

### DETAILED DESCRIPTION OF THE INVENTION

The present invention is directed to a method and device to cure and prevent athlete's foot in a shower setting.

With reference to the drawing Figures: The device 10 includes a cage or containment device 12a, 12b sufficient in size to accommodate required fungal treatment block or tablet 30. This apparatus 10 would be mounted to receive water spray 38 on the side of a shower 34, shower stall, bathtub, or wall 28 using one or more removable suction cups 26, or a more permanent mounting bracket 20 secured with screws 24, glue, tape, or any other adhesive included and/or deemed necessary. The dissolvable tablets 30 contain the medication or other desirable materials/minerals/herbal ingredients.

The most complete version of the present invention 10 includes a cage in two halves 12a, 12b, hinged one to the other via hinge portions 16a, 16b, and cooperating pin 16c, and resiliently held in a closed configuration by clip 14a, 14b. The cage is attached to bracket 18 using glue, double sided adhesive foam tape, a resilient snap, slotted receiver, or the equivalent. The cage is preferably 3″-6″ in diameter, approximately 1″-3″ deep, and made of plastic, polymer, stainless steel, or some other similarly corrosion resistant component. The cage could be produced in various colors, shapes, and sizes available by the production methods currently available at the time. In its most simplified form, the cage could be configured as simply a permeable pouch made of nylon or other durable mesh, hung to receive spray 38 from a proximate shower head 36. The cage could also be in the form of a mat placed on the floor of the shower area so that the water spray treatment of the floor could proceed. A suitable portable cage is shown in U.S. Pat. D 353,445, the contents of which are incorporated herein by reference. Such a mat could be used to treat large floor areas in communal shower arrangements (locker room showers, prisons, community pools, etc.) by simply placing many mats strategically in the shower area, or by moving them from active stall to active stall.

The current invention also includes a tablet 30 up to 6″ in diameter and up to 3″ thick. The tablet could be made in nearly any size, shape, scent, or color available by the production methods currently available at the time. The tablet would be comprised of an athlete's foot medication 40, bonded with inert fillers and substances to give it the desired size, shape, color, and/or scent. The strength, or dosage, of the athlete's foot medication could be varied in different tablet options to give the user a preference based on their needs.

The tablets could also be produced without an athlete's foot medication for a user desiring other effects. The tablet could include a fragrant substance bonded with fillers to create an aromatic environment that binds the scent to the feet; a skin softening agent 40a bonded with fillers that moisturizes and soothes the feet; or an herbal/organic substance bonded with fillers that the user finds desirable to their shower experience.

The cage/tablet combination could also be used in the treatment of other foot conditions if the proper medication(s) were put into the tablet. For example, the name brand Lamisil nail fungus treatment could be included in the dissolvable medicinal block placed inside the cage. It is also possible that this configuration could be used in an agricultural setting, such as a fertilizer tablet in a cage with a spike that is stuck in the dirt, and placed near a tree, bush, flower bed, etc. and the fertilizer is released when it rains or the user applies water to it. The current invention could also be fitted with a detergent or disinfecting tablet, used in a mechanical washer, such as a dishwasher, or in a large washer used in some hospitals to clean wheelchairs, stainless steel rolling cabinets used in surgery, or surgical instruments.

This method could be utilized in large shower settings, such as military bases, school locker room showers, dormitory showers, gym or recreation center showers, swimming pool showers, or other large publicly shared shower facilities, whereas current methods of treating athlete's foot are designed for individual usage and application. The procedure is simple and can benefit a single user in a private setting such as a house or apartment shower area, or many users in a shared shower setting.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims It is indeed intended that the scope of the invention should be determined by proper interpretation and construction of the appended claims and their legal equivalents, as understood by those of skill in the art relying upon the disclosure in this specification and the attached drawings.

1. An apparatus for coating a shower area with treated effluent during use, comprising:
containment means for surrounding and supporting a dis-solvable treatment tablet, said means being mounted on a wall surface proximate said shower area so as to receive water spray from said shower during use, whereby water spray passing through said containment means dis-solves said tablet and produces a treated effluent that flows to and coats a shower area over which said effluent passes.

2. An apparatus as in claim 1, wherein:
said treatment tablet includes anti-microbial and fungal treatment having an effect on athlete's foot.

3. An apparatus as in claim 1, wherein:
said treatment tablet includes skin treating agents for treating a shower user's feet during use of said shower.

4. An apparatus as in claim 1, wherein:
said containment means is a two piece cage with respective halves hinged one to the other in a clam shell association to capture said treatment tablet therein.

5. An apparatus as in claim 4, wherein:
said two piece cage is mounted to said wall using a bracket engaging said wall with a suction cup mount.

6. A method coating a shower area with treated effluent during use, comprising the steps of:
mounting a containment means, for surrounding and supporting a dis-solvable treatment tablet, on a surface proximate said shower area so as to receive water spray from said shower during use;
inserting a pre-selected treatment tablet into said containment means;
turning on said shower and directing water spray toward said containment means,
whereby water spray passing through said containment means dis-solves said tablet and produces a treated effluent that flows to and coats a shower area over which said effluent passes.

7. A method as in claim 6, wherein:
said treatment tablet includes anti-microbial and fungal treatment having an effect on athlete's foot.

8. A method as in claim 6, wherein:
said treatment tablet includes skin treating agents for treating a shower user's feet during use of said shower.
